(19) United States
(12) Patent Application Publication
(10) Pub. No.: US 2025/0270430 A1
(43) Pub. Date: Aug. 28, 2025

(54) LOW GWP FLUIDS FOR HIGH TEMPERATURE HEAT PUMP APPLICATIONS

(71) Applicant: HONEYWELL INTERNATIONAL INC., Charlotte, NC (US)

(72) Inventors: Bruno Yuji Kimura de Carvalho, Charlotte, NC (US); Ankit Sethi, Charlotte, NC (US)

(73) Assignee: HONEYWELL INTERNATIONAL INC., Charlotte, NC (US)

(21) Appl. No.: 19/054,549

(22) Filed: Feb. 14, 2025

Related U.S. Application Data
(60) Provisional application No. 63/558,088, filed on Feb. 26, 2024.

(51) Int. Cl. C09K 5/04; F25B 9/00

(52) U.S. Cl. CPC C09K 5/044; F25B 9/006; C09K 2205/122; C09K 2205/126; C09K 2205/22

(57) ABSTRACT

The present invention relates to refrigerants which include HFO-1233zd, HFO-1234ze(E), and HFC-152a and the use of such refrigerants in high temperature heat pumps.

### CROSS REFERENCE TO RELATED APPLICATION

This application is related to and claims the priority benefit of U.S. Provisional Application No. 63/558,088, filed Feb. 26, 2024, which is incorporated by reference herein in its entirety.

### FIELD OF THE INVENTION

This invention relates to compositions, methods and systems having utility in heat transfer applications, with particular benefit in high temperature heat pump applications, and in particular aspects to heat transfer and/or refrigerant compositions for replacement of or use instead of previously used refrigerants, including CFC-114, 1233zd(E) and 1234ze(Z), particularly for providing heating in high temperature heat pump systems.

### BACKGROUND

High temperature heat pumps have been used to upgrade low-grade thermal energy, such as that derived from air, soil, surface water or underground water, geothermal energy, solar energy, and industrial exhaust heat and process streams, to high-grade thermal energy via a thermodynamic cycle. Heat pump systems use a working fluid, i.e., a refrigerant, to facilitate the generation and transfer of heat over a vapor compression thermodynamic cycle. Heat pump systems have been used for both heating and cooling purposes.

Historically, certain chlorofluorocarbons were used as working fluids in heat pumps, refrigerators, and other heating/cooling devices and machines. For high temperature heat pumps, 1,2-dichloro-1,1,2,2-tetrafluoroethane (CFC-114) has been widely used. However, CFC-114 has a very high Global Warming Potential (GMP) of over 10,000. While CFC-114 has been replaced in some applications by refrigerants such as R-134a, R-227ea, R-236fa, or R-245fa, the use of materials such as these present significant disadvantage. For example, all of the above-noted refrigerants have relatively large GWPs, and R-134a and R-227ea have relatively low critical point temperatures, limiting their applicability to lower-temperature applications. As a result, there remains a continuing need for a more acceptable substitute for CFC-114 in high temperature heat pumps.

US Patent Publication 2016/0178255 has suggested that a heat transfer composition comprising the cis isomer of 1,3,3,3-tetrafluoropropene (HFO-1234ze(Z)) can be used in various heat transfer applications, including high temperature heat pump applications. While HFO-1234ze(Z) may possess some properties that could show advantage in high temperature heat pump applications, it has been acknowledged that the information about HFO-1234ze(Z) is relatively scarce. (See “The fluorinated olefin R-1234ze(Z) as a high-temperature heat pumping refrigerant,” Brown et al., International Journal of Refrigeration, Volume 32, Issue 6, September 2009, Pages 1412-1422). In particular, applicants have come to appreciate that the lack of sufficient information about the toxicity and flammability of HFO-1234ze(Z), together with the fact that this compound has not been registered for use in any geographical region, make this compound at present less than fully satisfactory for use in high temperature heat pump applications.

U.S. Pat. No. 9,850,414, which is assigned to the assignee of the present application, discloses the use of 1233zd(E), alone and in blends with other refrigerants, including 1234ze(E), in high temperature heat pump applications. U.S. Pat. No. 10,101,065 also discloses the use of 1233zd(E), as well as 1233zd(Z), in high temperature heat pumps. U.S. Pat. No. 11,827,834 discloses refrigerant blends comprising: (a) carbon dioxide; (b) a nonflammable low volatility component selected from the group consisting of: HFO1224yd(Z), HFO1224yd(E), HFO1233zd(E), HFO1233zd(Z), HFO1233xf, HFO1336mzz(E), HFO1336mzz(Z), 2-bromo-3,3,3-trifluoroprop-1-ene; or mixtures thereof; (c) an intermediate volatility component selected from the group consisting of: HFO1234yf, HFO1234ze(E), HFO-1225ye(Z) and HFO1243zf or mixtures thereof; and (d) optionally a component selected from HFC-227ea, HFC-152a, HFC-32 or mixtures thereof. One use of the refrigerant blends disclosed in the '834 patent is heat pump applications. While significant advantages are associated with the use of 1233zd(E) as disclosed in the '414 patent, applicants have come to appreciate that improvements can be achieved in connection with the cost and complexity of equipment, including particularly compressors, that are used in connection with such systems by the selection of new and advantageous refrigerant blends.

Thus, applicants have come to appreciate the need for, and/or the potential substantial advantage to be achieved by, a working fluid in a high temperature heat pump that exhibits low ODP, low GWP, low flammability, acceptable toxicity, and excellent thermal performance in the high temperature ranges (including preferably high capacity relative to neat 1233zd(E), particularly in systems that use a high heat sink temperature of about 60° C. or greater) to condense the refrigerant. Applicants have come to appreciate the need for use of such working fluids in new systems, but also a need for a working fluid that is advantageous as a replacement for and/or instead of CFC-114 and/or HFO-1234ze(Z) and/or 1233zd(E) in high temperature heat pump systems.

The present invention is able to achieve exceptional advantage in connection with large, central plant heat pump systems, especially for district heating. In such systems, a shared central system is utilized as the heat source, such as ground loop borehole arrays, air source systems and heat recovery from industrial processes. Such systems will typically provide heat to several blocks of homes, town homes and the like, or one or more high rise apartment buildings. Such arrangements are known as and referred to herein as district heating applications, and a rack of relatively large compressors are typically used in such systems. Applicants have come to appreciate that such systems can receive unexpected advantage by use of the present refrigerants, systems and methods in that the refrigerants are not only environmentally friendly and A2L or A1, they provide a capacity at least about 20% higher than currently used heat pump refrigerants, especially 1233zd(E). In such a case it is possible to implement the present invention at a substantial and significant cost savings in view of the ability to purchase for the system a total compressor displacement that is at least 15% smaller than used in prior systems, which thus affords a substantial savings in installed cost and potentially maintenance costs over the life of the installation.

These and/or other needs are satisfied by the inventive refrigerants, heat transfer composition, systems and methods described herein.

### SUMMARY

Applicants have unexpectedly and advantageously found, as described in detail herein, that compositions based on carefully selected amounts of the combination of HFO-1233zd(E), HFO-1234ze(E) and HFC-152a can provide refrigerants that satisfy many, and preferably all, of the requirements discussed above, as well additional requirements and/or advantages as described hereinafter.

Applicants have discovered refrigerants, heat transfer compositions, refrigeration methods and systems, which utilize one or more of the compositions of the present invention as a refrigerant, including and especially in connection with high temperature heat pump applications.

The present invention includes refrigerants comprising:
(1) from 81% to 89% by weight of HFO-1233zd(E);
(2) from 4% to 15% by weight of HFO-1234ze(E); and
(3) from about 2% to 9% by weight of HFC-152a,
   wherein said refrigerant has (i) a Global Warming Potential (GWP) of 10 or less; (ii) a flammability of 2 L; and (iii) a critical temperature of greater than 150° C.
   The refrigerant according to this paragraph is sometimes referred to herein for convenience as Refrigerant 1A.

The present invention includes refrigerants consisting essentially of:
(1) from 81% to about 89% by weight of HFO-1233zd(E);
(2) from 4% to 15% by weight of HFO-1234ze(E); and
(3) from 2% to 9% by weight of HFC-152a.
   The refrigerant according to this paragraph is sometimes referred to herein for convenience as Refrigerant 1B.

The present invention includes refrigerants consisting of:
(4) from 81% to 89% by weight of HFO-1233zd(E);
(5) from 4% to 15% by weight of HFO-1234ze(E); and
(6) from 2% to 9% by weight of HFC-152a.
   The refrigerant according to this paragraph is sometimes referred to herein for convenience as Refrigerant 1C.

The present invention includes refrigerants comprising:
(1) from 83% to 89% by weight of HFO-1233zd(E);
(2) from 7% to 11% by weight of HFO-1234ze(E); and
(3) from 3% to 7% by weight of HFC-152a.
   The refrigerant according to this paragraph is sometimes referred to herein for convenience as Refrigerant 2A.

The present invention includes refrigerants consisting essentially of:
(1) from 83% to 89% by weight of HFO-1233zd(E);
(2) from 7% to 11% by weight of HFO-1234ze(E); and
(3) from 3% to 11% by weight of HFC-152a.
   The refrigerant according to this paragraph is sometimes referred to herein for convenience as Refrigerant 2B.

The present invention includes refrigerants consisting of:
(1) from 83% to 89% by weight of HFO-1233zd(E);
(2) from 7% to 11% by weight of HFO-1234ze(E); and
(3) from 3% to 7% by weight of HFC-152a.
   The refrigerant according to this paragraph is sometimes referred to herein for convenience as Refrigerant 2C.

The present invention includes refrigerants comprising at least about 95% by weight based on the total of all refrigerants of the following three components in the following relative concentrations:
(1) from 81% to 86% by weight of HFO-1233zd(E);
(2) from 10% to 13% by weight of HFO-1234ze(E); and
(3) from 3% to 7% by weight of HFC-152a,
   The refrigerant according to this paragraph is sometimes referred to herein for convenience as Refrigerant 3A.

The present invention includes refrigerants consisting essentially of:
(1) from 81% to 86% by weight of HFO-1233zd(E);
(2) from 10% to 13% by weight of HFO-1234ze(E); and
(3) from 4% to 7% by weight of HFC-152a.
   The refrigerant according to this paragraph is sometimes referred to herein for convenience as Refrigerant 3B.

The present invention includes refrigerants consisting of:
(1) from 81% to 86% by weight of HFO-1233zd(E);
(2) from 10% to 13% by weight of HFO-1234ze(E); and
   from 4% to 7% by weight of HFC-152a. The refrigerant according to this paragraph is sometimes referred to herein for convenience as Refrigerant 3C.

The present invention includes refrigerants consisting essentially of the following three components in the following relative concentrations:
(1) 86.2%+/−2% by weight of HFO-1233zd(E);
(2) 8.8%+/−1% by weight of HFO-1234ze(E); and
(3) 5%+/−1% by weight of HFC-152a.
   The refrigerant according to this paragraph is sometimes referred to herein for convenience as Refrigerant 4A.

The present invention includes refrigerants consisting of:
(1) 86.2%+/−2% by weight of HFO-1233zd(E);
(2) 8.8%+/−1% by weight of HFO-1234ze(E); and
(3) 5%+/−1% by weight of HFC-152a.
   The refrigerant according to this paragraph is sometimes referred to herein for convenience as Refrigerant 4B

The present invention includes refrigerants consisting essentially of the following three components in the following relative concentrations:
(1) 83.2%+/−2% by weight of HFO-1233zd(E);
(2) 11.8%+/−1% by weight of HFO-1234ze(E); and
(3) 5%+/−1% by weight of HFC-152a.
   The refrigerant according to this paragraph is sometimes referred to herein for convenience as Refrigerant 5A.

The present invention includes refrigerants consisting of:
(1) 83.2%+/−2% by weight of HFO-1233zd(E);
(2) 11.8%+/−1% by weight of HFO-1234ze(E); and
(3) 5%+/−1% by weight of HFC-152a.
   The refrigerant according to this paragraph is sometimes referred to herein for convenience as Refrigerant 5B.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 130° C. and a direct expansion evaporator transferring heat from a heat source at a temperature of from about 30° C. to about 90° C. to said refrigerant in the liquid phase, wherein said refrigerant comprises:
   a. from about 83% to about 89% by weight of HFO-1233zd(E);
   b. from about 4% to about 15% by weight of HFO-1234ze(E); and
   c. from about 2% to about 8% by weight of HFC-152a, wherein said refrigerant has (i) a Global Warming Potential (GWP) of 10 or less; (ii) a flammability of 2 L; and (iii) a critical temperature of greater than 150° C.; and
(2) evaporating said refrigerant in said direct expansion evaporator, wherein said refrigerant has a volumetric capacity in said system that is at least about 120% of the volumetric capacity of R-1233zd(E) in said system.
   The method according to this paragraph is sometimes referred to herein for convenience as Heat Transfer Method 1A.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 130° C., and a direct expansion evaporator transferring heat from a heat source at a temperature of from about 30° C. to about 90° c. to said refrigerant in the liquid phase, wherein said refrigerant comprises:
   a. from about 81% to about 89% by weight of HFO-1233zd(E);
   b. from about 4% to about 15% by weight of HFO-1234ze(E); and
   c. from about 2% to about 9% by weight of HFC-152a, wherein said refrigerant has (i) a Global Warming Potential (GWP) of 10 or less; (ii) a flammability of 2 L; and (iii) a critical temperature of greater than 150° C.; and
(2) evaporating said refrigerant in said direct expansion evaporator, wherein said refrigerant has a COP in said system that is at least 96% of the COP of R-1233zd(E) in said system.
   The method according to this paragraph is sometimes referred to herein for convenience as Heat Transfer Method 1B.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 130° C., and a direct expansion evaporator transferring heat from a heat source at a temperature of from about 30° C. to about 90° C. to said refrigerant in the liquid phase, wherein said refrigerant comprises:
   (1) from about 81% to about 89% by weight of HFO-1233zd(E);
   (2) from about 4% to about 15% by weight of HFO-1234ze(E); and
   (3) from about 2% to about 9% by weight of HFC-152a, wherein said refrigerant has (i) a Global Warming Potential (GWP) of 10 or less; (ii) a flammability of 2 L; and (iii) a critical temperature of greater than 150° C.; and
(2) evaporating said refrigerant in said direct expansion evaporator, wherein said refrigerant has (i) a volumetric capacity in said system that is at least about 120% of the volumetric capacity of R-1233zd(E) in said system and (ii) a COP in said system that is at least 96% of the COP of R-1233zd(E) in said system.
   The method according to this paragraph is sometimes referred to herein for convenience as Heat Transfer Method 1C.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) from about 83% to about 89% by weight of HFO-1233zd(E);
   (b) from about 4% to about 15% by weight of HFO-1234ze(E); and
   (c) from about 2% to about 8% by weight of HFC-152a, wherein said refrigerant is 2 L; and
(2) evaporating said refrigerant in said direct expansion evaporator, wherein said refrigerant has a volumetric capacity in said system that is at least about 120% of the volumetric capacity of R-1233zd(E) in said system.
   The method according to this paragraph is sometimes referred to herein for convenience as Heat Transfer Method 2A.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) from about 83% to about 89% by weight of HFO-1233zd(E);
   (b) from about 4% to about 15% by weight of HFO-1234ze(E); and
   (c) from about 2% to about 8% by weight of HFC-152a, wherein said refrigerant is 2 L; and
(2) evaporating said refrigerant in said direct expansion evaporator, wherein said refrigerant has a COP in said system that is at least 96% of the COP of R-1233zd(E) in said system.
   The method according to this paragraph is sometimes referred to herein for convenience as Heat Transfer Method 2B.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) from about 83% to about 89% by weight of HFO-1233zd(E);
   (b) from about 4% to about 15% by weight of HFO-1234ze(E); and
   (c) from about 2% to about 8% by weight of HFC-152a, wherein said refrigerant is 2 L; and
(2) evaporating said refrigerant in said direct expansion evaporator, wherein said refrigerant has: (i) a volumetric capacity in said system that is at least about 120% of the volumetric capacity of R-1233zd(E) in said system; and (ii) a COP in said system that is at least 96% of the COP of R-1233zd(E) in said system.
   The method according to this paragraph is sometimes referred to herein for convenience as Heat Transfer Method 2C.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) from about 83% to about 89% by weight of HFO-1233zd(E);
   (b) from about 4% to about 15% by weight of HFO-1234ze(E); and
   (c) from about 2% to about 8% by weight of HFC-152a, wherein said refrigerant is 2 L; and
(2) evaporating said refrigerant in said direct expansion evaporator, wherein said refrigerant has: (i) a volumetric capacity in said system that is at least about 120% of the volumetric capacity of R-1233zd(E) in said system; and (ii) a COP in said system that is at least 96% of the COP of R-1233zd(E) in said system and (iii) an evaporator glide in said system of from about 1° C. to less than about 15° C.
   The method according to this paragraph is sometimes referred to herein for convenience as Heat Transfer Method 2D.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant consisting essentially of the following three components in the following relative concentrations:
   a. 86.2%+/−2% by weight of HFO-1233zd(E);
   b. 8.8%+/−1% by weight of HFO-1234ze(E); and
   c. 5%+/−1% by weight of HFC-152a; and
(2) evaporating said refrigerant in said direct expansion evaporator, wherein said refrigerant has a volumetric capacity in said system that is at least about 120% of the volumetric capacity of R-1233zd(E) in said system.
   The method according to this paragraph is sometimes referred to herein for convenience as Heat Transfer Method 3A.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) 86.2%+/−2% by weight of HFO-1233zd(E);
   (b) 8.8%+/−1% by weight of HFO-1234ze(E); and
   (c) 5%+/−1% by weight of HFC-152a, wherein said refrigerant is 2 L; and
(2) evaporating said refrigerant in said direct expansion evaporator, wherein said refrigerant has a COP in said system that is at least 96% of the COP of R-1233zd(E) in said system.
   The method according to this paragraph is sometimes referred to herein for convenience as Heat Transfer Method 3B.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) 86.2%+/−2% by weight of HFO-1233zd(E);
   (b) 8.8%+/−1% by weight of HFO-1234ze(E); and
   (c) 5%+/−1% by weight of HFC-152a, wherein said refrigerant is 2 L; and
(2) evaporating said refrigerant in said direct expansion evaporator, wherein said refrigerant has: (i) a volumetric capacity in said system that is at least about 120% of the volumetric capacity of R-1233zd(E) in said system; and (ii) a COP in said system that is at least 96% of the COP of R-1233zd(E) in said system.
   The method according to this paragraph is sometimes referred to herein for convenience as Heat Transfer Method 3C.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) 86.2%+/−2% by weight of HFO-1233zd(E);
   (b) 8.8%+/−1% by weight of HFO-1234ze(E); and
   (c) 5%+/−1% by weight of HFC-152a, wherein said refrigerant is 2 L; and
(2) evaporating said refrigerant in said direct expansion evaporator, wherein said refrigerant has: (i) a volumetric capacity in said system that is at least about 120% of the volumetric capacity of R-1233zd(E) in said system; and (ii) a COP in said system that is at least 96% of the COP of R-1233zd(E) in said system and (iii) an evaporator glide in said system of from about 1° C. to less than about 15° C.
   The method according to this paragraph is sometimes referred to herein for convenience as Heat Transfer Method 3D.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant consisting essentially of the following three components in the following relative concentrations:
   a. 83.2%+/−2% by weight of HFO-1233zd(E);
   b. 11.8%+/−1% by weight of HFO-1234ze(E); and
   c. 5%+/−1% by weight of HFC-152a; and
(2) evaporating said refrigerant in said direct expansion evaporator, wherein said refrigerant has a volumetric capacity in said system that is at least about 120% of the volumetric capacity of R-1233zd(E) in said system.
   The method according to this paragraph is sometimes referred to herein for convenience as Heat Transfer Method 4A.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) 83.2%+/−2% by weight of HFO-1233zd(E);
   (b) 11.8%+/−1% by weight of HFO-1234ze(E); and
   (c) 5%+/−1% by weight of HFC-152a, wherein said refrigerant is 2 L; and
(2) evaporating said refrigerant in said direct expansion evaporator, wherein said refrigerant has a COP in said system that is at least 96% of the COP of R-1233zd(E) in said system.
   The method according to this paragraph is sometimes referred to herein for convenience as Heat Transfer Method 4B.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) 83.2%+/−2% by weight of HFO-1233zd(E);
   (b) 11.8%+/−1% by weight of HFO-1234ze(E); and
   (c) 5%+/−1% by weight of HFC-152a, wherein said refrigerant is 2 L; and
(2) evaporating said refrigerant in said direct expansion evaporator, wherein said refrigerant has: (i) a volumetric capacity in said system that is at least about 120% of the volumetric capacity of R-1233zd(E) in said system; and (ii) a COP in said system that is at least 96% of the COP of R-1233zd(E) in said system.
   The method according to this paragraph is sometimes referred to herein for convenience as Heat Transfer Method 4C.

The present invention includes a method of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of about 90° C.-130° C. and a direct expansion evaporator transferring heat from a heat source at a temperature of from about 30° C. to about 90° C. to said refrigerant in the liquid phase, wherein said refrigerant comprises:
   (a) 83.2%+/−2% by weight of HFO-1233zd(E);
   (b) 11.8%+/−1% by weight of HFO-1234ze(E); and
   (c) 5%+/−1% by weight of HFC-152a, wherein said refrigerant is 2 L; and
(2) evaporating said refrigerant in said direct expansion evaporator, wherein said refrigerant has: (i) a volumetric capacity in said system that is at least about 120% of the volumetric capacity of R-1233zd(E) in said system; and (ii) a COP in said system that is at least 96% of the COP of R-1233zd(E) in said system and (iii) an evaporator glide in said system of from about 1° C. to less than about 15° C.
   The method according to this paragraph is sometimes referred to herein for convenience as Heat Transfer Method 4D.

The present invention includes a method of providing district heating to a plurality of residential spaces comprising:
(1) a vapor compression refrigeration system comprising one or more compressors receiving refrigerant vapors from one or more direct expansion evaporators, one or more condensers receiving compressed refrigerant vapor from said one or more compressors and producing condensed liquid refrigerant feeding one or more expanders which produce liquid refrigerant feeding said one or more evaporators;
(2) providing a heat source at a temperature of from about 30° C. to about 90° C. which directly or indirectly evaporates said liquid refrigerant in said one or more evaporators,
(3) providing a heat sink which directly or indirectly condenses said vaporous refrigerant in said condenser, wherein at least said one or more compressors is not located in said residences and wherein said heat sink comprises air and/or water circulating in said residences at a temperature of from about 90° C. to about 130° C. and wherein said refrigerant comprises:
   (a) from 83% to 89% by weight of HFO-1233zd(E);
   (b) from 4% to 15% by weight of HFO-1234ze(E); and
   (c) from 2% to 9% by weight of HFC-152a, wherein said refrigerant is 2 L; and
(4) evaporating said refrigerant in said direct expansion evaporator, wherein said refrigerant has a volumetric capacity in said system that is at least about 120% of the volumetric capacity of R-1233zd(E) in said system.
   The method according to this paragraph is sometimes referred to herein for convenience as Heat Transfer Method 5A.

The present invention includes a method of providing district heating to a plurality of residential spaces comprising:
(1) a vapor compression refrigeration system comprising one or more compressors receiving refrigerant vapors from one or more direct expansion evaporators, one or more condensers receiving compressed refrigerant vapor from said one or more compressors and producing condensed liquid refrigerant feeding one or more expanders which produce liquid refrigerant feeding said one or more evaporators;
(2) providing a heat source at a temperature of from about 30° C. to about 90° C. which directly or indirectly evaporates said liquid refrigerant in said one or more evaporators,
(3) providing a heat sink which directly or indirectly condenses said vaporous refrigerant in said condenser, wherein at least said one or more compressors is not located in said residences, wherein said heat sink comprises air and/or water circulating in said residences at a temperature of from about 90° C. to about 130° C. and wherein said refrigerant comprises:
   (a) from 81% to 89% by weight of HFO-1233zd(E);
   (b) from 4% to 15% by weight of HFO-1234ze(E); and
   (c) from 2% to 9% by weight of HFC-152a, wherein said refrigerant is 2 L; and
(4) evaporating said refrigerant in said direct expansion evaporator, wherein said refrigerant has a COP in said system that is at least 96% of the COP of R-1233zd(E) in said system.
   The method according to this paragraph is sometimes referred to herein for convenience as Heat Transfer Method 5B.

The present invention includes a method of providing district heating to a plurality of residential spaces comprising:
(1) a vapor compression refrigeration system comprising one or more compressors receiving refrigerant vapors from one or more direct expansion evaporators, one or more condensers receiving compressed refrigerant vapor from said one or more compressors and producing condensed liquid refrigerant feeding one or more expanders which produce liquid refrigerant feeding said one or more evaporators;
(2) providing a heat source at a temperature of from about 30° C. to about 90° C. which directly or indirectly evaporates said liquid refrigerant in said one or more evaporators,
(3) providing a heat sink which directly or indirectly condenses said vaporous refrigerant in said condenser, wherein at least said one or more compressors is not located in said residences, wherein said heat sink comprises air and/or water circulating in said residences at a temperature of from about 90° C. to about 130° C. and wherein said refrigerant comprises:
   (a) from 81% to 89% by weight of HFO-1233zd(E);
   (b) from 4% to 15% by weight of HFO-1234ze(E); and
   (c) from 2% to 9% by weight of HFC-152a, wherein said refrigerant is 2 L; and
(4) evaporating said refrigerant in said direct expansion evaporator, wherein said refrigerant has: (i) a volumetric capacity in said system that is at least about 120% of the volumetric capacity of R-1233zd(E) in said system; and (ii) a COP in said system that is at least 96% of the COP of R-1233zd(E) in said system.
   The method according to this paragraph is sometimes referred to herein for convenience as Heat Transfer Method 5C.

The present invention includes a method of providing district heating to a plurality of residential spaces comprising:
(1) a vapor compression refrigeration system comprising one or more compressors receiving refrigerant vapors from one or more direct expansion evaporators, one or more condensers receiving compressed refrigerant vapor from said one or more compressors and producing condensed liquid refrigerant feeding one or more expanders which produce liquid refrigerant feeding said one or more evaporators;
(2) providing a heat source at a temperature of from about 30° C. to about 90° C. which directly or indirectly evaporates said liquid refrigerant in said one or more evaporators,
(3) providing a heat sink which directly or indirectly condenses said vaporous refrigerant in said condenser, wherein at least said one or more compressors is not located in said residences, wherein said heat sink comprises air and/or water circulating in said residences at a temperature of from about 90° C. to about 130° C. and wherein said refrigerant comprises:
   (a) from 81% to 89% by weight of HFO-1233zd(E);
   (b) from 4% to 15% by weight of HFO-1234ze(E); and
   (c) from 2% to 9% by weight of HFC-152a, wherein said refrigerant is 2 L; and
(4) evaporating said refrigerant in said direct expansion evaporator, wherein said refrigerant has: (i) a volumetric capacity in said system that is at least about 120% of the volumetric capacity of R-1233zd(E) in said system; (ii) a COP in said system that is at least 96% of the COP of R-1233zd(E) in said system; and (iii) an evaporator glide of from about 2° C. to less than about 10° C.
   The method according to this paragraph is sometimes referred to herein for convenience as Heat Transfer Method 5D.

The present invention includes a method of providing district heating to a plurality of residential spaces comprising:
(1) a vapor compression refrigeration system comprising one or more compressors receiving refrigerant vapors from one or more direct expansion evaporators, one or more condensers receiving compressed refrigerant vapor from said one or more compressors and producing condensed liquid refrigerant feeding one or more expanders which produce liquid refrigerant feeding said one or more evaporators;
(2) providing a heat source at a temperature of from about 30° C. to about 90° C. which directly or indirectly evaporates said liquid refrigerant in said one or more evaporators,
(3) providing a heat sink which directly or indirectly condenses said vaporous refrigerant in said condenser, wherein said heat sink comprises air and/or water circulating in each of said plurality of residences, wherein at least said one or more compressors is not located in said residences, wherein said heat sink comprises air and/or water circulating in said residences at a temperature of from about 90° C. to about 130° C. and wherein said refrigerant comprises:
   (a) from t 81% to 89% by weight of HFO-1233zd(E);
   (b) from 4% to 15% by weight of HFO-1234ze(E); and
   (c) from 2% to 8% by weight of HFC-152a, wherein said refrigerant is 2 L; and
(4) evaporating said refrigerant in said direct expansion evaporator, wherein said refrigerant has: (i) a volumetric capacity in said system that is at least about 120% of the volumetric capacity of R-1233zd(E) in said system; (ii) a COP in said system that is at least 96% of the COP of R-1233zd(E) in said system; and (iii) an evaporator glide of from about 2° C. to less than about 10° C.
   The method according to this paragraph is sometimes referred to herein for convenience as Heat Transfer Method 5D.

The present invention also includes a method of reducing the cost of forming a high temperature heat pump system for providing heat to a heat sink comprising a fluid or body to be heated comprising:
(1) providing a vapor compression refrigeration system comprising:
   a. a compressor for compressing a refrigerant in a vapor phase, wherein said compressor has a displacement which is at least about 15% less than the compressor displacement required to achieve the same capacity in said system using a refrigerant consisting of 1233zd(E);
   b. a condenser transferring heat, directly or indirectly, from said vapor phase refrigerant to the heat sink, wherein said heat sink is at a temperature of from about 90° C. about 130° C., and a direct expansion evaporator transferring heat, directly or indirectly, from a heat source, wherein said heat source is at a temperature of from about 30° C. to about 90° C. to said refrigerant in the liquid phase, wherein said refrigerant comprises:
      i. from 81% to 89% by weight of HFO-1233zd(E);
      ii. from 4% to 15% by weight of HFO-1234ze(E); and
      iii. from 2% to 9% by weight of HFC-152a, wherein said refrigerant is 2 L; and
(2) evaporating said refrigerant in said direct expansion evaporator, wherein said refrigerant has a COP in said system that is at least 96% of the capacity of R-1233zd(E) in said system.
   The method according to this paragraph is sometimes referred to herein for convenience as Heat Pump Cost Reduction Method 1.

The present invention includes a vapor compression heat pump providing heat to a heat sink comprising a fluid or body to be heated comprising:
(1) a refrigerant;
(2) a compressor for compressing said refrigerant in a vapor phase;
(3) a condenser transferring heat from said vapor phase refrigerant, directly or indirectly, to the heat sink at a temperature of from about 90° C. to about 130° C.; and
(4) a direct expansion evaporator transferring heat from a heat source at a temperature of from about 30° C. to about 90° C. to said refrigerant in the liquid phase,
(5) wherein said refrigerant comprises:
   i. from 81% to 89% by weight of HFO-1233zd(E);
   ii. from 4% to 15% by weight of HFO-1234ze(E); and
   iii. from 2% to 9% by weight of HFC-152a,
wherein said refrigerant: (a) is 2 L; and (b) has a capacity in said system that is at least about 120% of the capacity of R-1233zd(E) in said system.
   The heat pump according to this paragraph is sometimes referred to herein for convenience as Heat Pump 1A.

The present invention includes a vapor compression heat pump providing heat to a heat sink comprising a fluid or body to be heated comprising:
(1) a refrigerant;
(2) a compressor for compressing said refrigerant in a vapor phase;
(3) a condenser transferring heat from said vapor phase refrigerant, directly or indirectly, to the heat sink at a temperature of from about 90° C. to about 130° C.; and
(4) a direct expansion evaporator transferring heat from a heat source at a temperature of from about 30° C. to about 90° C. to said refrigerant in the liquid phase,
(5) wherein said refrigerant comprises:
   i. from 81% to 89% by weight of HFO-1233zd(E);
   ii. from 4% to 15% by weight of HFO-1234ze(E); and
   iii. from 2% to 9% by weight of HFC-152a,
      wherein said refrigerant: (a) is 2 L; and (b) has a COP that is at least about 96% of the COP of R-1233zd(E) in said system.
      The heat pump according to this paragraph is sometimes referred to herein for convenience as Heat Pump 1B.

The present invention includes a vapor compression heat pump providing heat to a heat sink comprising a fluid or body to be heated comprising:
(1) a refrigerant;
(2) a compressor for compressing said refrigerant in a vapor phase;
(3) a condenser transferring heat from said vapor phase refrigerant, directly or indirectly, to the heat sink at a temperature of from about 90° C. to about 130° C.; and
(4) a direct expansion evaporator transferring heat from a heat source at a temperature of from about 30° C. to about 90° C. to said refrigerant in the liquid phase,
wherein said refrigerant comprises:
   i. from 81% to 89% by weight of HFO-1233zd(E);
   ii. from 4% to 15% by weight of HFO-1234ze(E); and
   iii. from 2% to 8% by weight of HFC-152a,
wherein said refrigerant: (a) is 2 L; (b) has a capacity in said system that is at least about 120% of the capacity of R-1233zd(E) in said system; and (c) has a COP that is at least about 96% of the COP of R-1233zd(E) in said system.

The heat pump according to this paragraph is sometimes referred to herein for convenience as Heat Pump 1C.

### BRIEF DESCRIPTION OF THE FIGURES

FIG. 1 is a schematic representation of an exemplary heat transfer system that can use the present refrigerants, and which can be used in the present systems and methods, including high temperature heat pump systems and methods.

### DETAILED DESCRIPTION

### Definitions:

The phrase “coefficient of performance” (herein abbreviated as “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration, cooling or heating capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “Global Warming Potential” (herein abbreviated as “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fourth Assessment Report, 20141, referred to and abbreviated herein as AR4, except for components that did not have a GWP value measured in AR4 (such as R1233zd(E) and R1234ze(E)), then the values used are according to the Fifth Assessment Report.

The term “non-flammable” as used herein refers to compounds or compositions which are determined to be either class 1 or 2 L under ASHRAE 34-2016 test protocol defining conditions and apparatus and using the current method ASTM E681-09 annex A1. Accordingly, a refrigerant which is not classified as either Class 1 or Class 2 L under ASHRAE 34-2016 test protocol defining conditions and apparatus and using the current method ASTM E681-09 annex A1 would be considered flammable herein. ASTM Standard E-681-2009 Standard Test Method for Concentration Limits of Flammability of Chemicals (Vapors and Gases) at conditions described in ASHRAE Standard 34-2016 Designation and Safety Classification of Refrigerants and described in Appendix B1 to ASHRAE Standard 34-2016 (as each standard exists as of the filing date of this application), are incorporated herein by reference in their entireties.

The phrase “acceptable toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and acceptable-toxicity, or mildly flammable and acceptable-toxicity, would be classified as “A1” or as “A2 L” by ASHRAE Standard 34-2016 Designation and Safety Classification of Refrigerants
Myhre, G., D. Shindell, F.-M. Breon, W. Collins, J. Fuglestvedt, J. Huang, D. Koch, J.-F. Lamarque, D. Lee, B. Mendoza, T. Nakajima, A. Robock, G.
Stephens, T. Takemura and H. Zhang, 2013: Anthropogenic and Natural Radiative Forcing. In: Climate Change 2013: The Physical Science Basis.
Contribution of Working Group I to the Fifth Assessment Report of the Intergovernmental Panel on Climate Change [Stocker, T. F., D. Qin, G.-K.
Plattner, M. Tignor, S. K. Allen, J. Boschung, A. Nauels, Y. Xia, V. Bex and P. M. Midgley (eds.)]. Cambridge University Press, Cambridge, United Kingdom and New York, NY, USA. https://www.ipcc.ch/pdf/assessmentreport/ar5/wg1/WG1AR5_Chapter08_FINAL.pdf (p. 73-79) and described in Appendix B1 to ASHRAE Standard 34-2016 (as each standard exists as of the filing date of this application).

As the term is used herein, “replacement for” with respect to a particular heat transfer composition or refrigerant of the present invention as a “replacement for” a particular prior refrigerant means the use of the indicated composition of the present invention in a heat transfer system that heretofore had been commonly used with that prior refrigerant. By way of example, when a refrigerant or heat transfer composition of the present invention is used in a heat transfer system that has heretofore been designed for and/or commonly used with R410A, such as residential air conditioning and commercial air conditioning (including roof top systems, variable refrigerant flow (VRF) systems and chiller systems) then the present refrigerant is a replacement for R410A is such systems.

The term “degree of superheat” or simply “superheat” means the temperature rise of the refrigerant at the exit of the evaporator above the saturated vapor temperature (or dew temperature) of the refrigerant.

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase ‘saturation temperature” means the temperature at which the liquid refrigerant boils into vapor at a given pressure.

As used herein, the term “condenser glide” means the difference between the dew point temperature of the refrigerant at or near the entrance to the condenser and the saturation temperature of the refrigerant at or near the exit of the condenser, assuming the pressure at the condenser exit is the same as the pressure at the inlet. As used herein, the phrase ‘saturation temperature” means the temperature at which the liquid refrigerant boils into vapor at a given pressure.

As used herein, the terms “direct expansion evaporator” and “Dx Evaporator” means a heat exchanger which receives a zeotropic liquid refrigerant blend and produces an unfractionated, superheated vapor of said zeotropic refrigerant blend.

As used herein, the term “flooded evaporator” means a heat exchanger which transfers heat to a boiling reservoir of liquid refrigerant.

As used herein, the term “district heating” means a system or method for heating a plurality of closely located residential spaces, such as in high rise apartment complexes, using a shared heat source loop or a series of shared heat source loops, such as one or a series of geothermal ground bore loops.

As used herein, the term “shallow geothermal heat source” means heat extracted from the earth at depths of from 2 meters to 500 meters.

The terms “1234ze” and “HFO-1234ze,” and “R1234ze” as used herein each means 1,1,1,3-tetrafluoropropene, without limitation as to isomeric form.

The terms trans1234ze, 1234ze(E), and R-1234ze(E) as used herein each means trans1,3,3,3-tetrafluoropropene.

The terms cis1234ze and 1234ze(Z) as used herein each means cis1,3,3,3-tetrafluoropropene.

The terms 1233zd as used herein means 1-chloro-3,3,3-trifluoropropene, without limitation as to isomeric form.

The terms trans1233zd and 1233zd(E) as used herein each means trans1-chloro-3,3,3-trifluoropropene.

The terms “R-152a” and “HFC-152a” as used herein each mean 1,1-difluoroethane.

The term “R-134a” and “HFC-134a” as used herein each means 1,1,1,2-tetrafluoroethane.

As used herein the terms “high temperature heat pump system” and “high temperature heat pump” means a vapor compression system operable in a heating mode in which the condensing temperature of the refrigerant is about 700C or higher.

As used herein, reference to a defined group, such as “Refrigerant 1-5,” refers to each composition within that group, including wherein a definition number includes a suffix. For example, reference to Refrigerant 1-2 includes reference to each of Refrigerant 1A, Refrigerant 1B, Refrigerant 1C, Refrigerant 2A, Refrigerant 2B and Refrigerant 2C.

As used herein, the term “about” in relation to the amount expressed in weight percent means that the amount of the component can vary by an amount of +/−10% on a relative basis by weight. Thus, if an amount is described as being “about 10 wt. %,” then it is intended to cover amounts of 10 wt. %+/−1 wt. %, and if an amount is described as being “about 20 wt. %,” then it is intended to cover amounts of 20 wt. %+/−2 wt. %, etc.

### Heat Pumps

A high temperature heat pump (sometimes referred to herein for convenience as “HTHP”) in its basic configuration comprises a fluid circuit which utilizes a circulating refrigerant to take-up or absorb heat from at least a first reservoir of heat (sometimes referred to herein as a “heat source”) at a relatively low temperature (sometimes referred to herein for convenience as a “low temperature heat source”) and then emitting or transmitting heat to at least a second reservoir which absorbs the heat (sometimes referred to herein as a heat sink) at a relatively high temperature (sometimes referred to herein for convenience as a “high temperature heat sink”). In preferred configurations the low temperature heat source is a plentiful source of heat at a relatively low temperature, such as might be available from low temperature industrial waste heat, geothermal energy from the ground and/or ground water, and the like, and the high temperature heat sink is a fluid which is desired to maintain in a relatively higher temperature range, such as hot water or steam or hot air.

The temperature of the low temperature heat source to be used in connection with the present refrigerants, systems and methods can vary widely, but in preferred embodiments will provide heat at temperatures of from about 5° C. to about 90° C., or from about 25° C. to about 90° C., or from about 40° C. to about 90° C., or from about 50° C. to about 90° C., or from about 40° C. to about 80° C., or from about 30° C. to about 80° C. or from about 5C to about 20° C., or from about 5° C. to about 15° C. Examples of low temperature heat sources useful in connection with the present invention include low grade industrial heat, air from the environment, water from the environment, brine, and in the case of geothermal energy, from the earth, including ground water.

With respect to the high temperature heat sinks which can absorb heat according the present invention, the present invention is believed to be useful for a wide range of such heat sinks, including hot air, hot water (i.e., hot water at a temperature of at least about 55° C.), and steam.

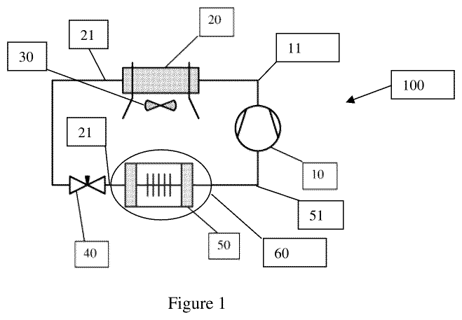

FIG. 1 is a generalized schematic view of a basic high-temperature heat pump device which contains and operates with the refrigerants of the present invention, including each of Refrigerants 1 to 5.

FIG. 1 illustrates in block diagram form a HTHP 100 according to the present invention includes an evaporator 50 that receives heat from the low temperature heat source (represented schematically by the oval 60), including by undergoing a phase change from liquid to vapor as heat is absorbed from the low temperature heat source. It will be appreciated, however, that some level of sensible heat may also transferred to the refrigerants of the present invention, including each of Refrigerants 1-5, by the low temperature heat source. The vaporous refrigerant which exits evaporator 50 via line 51 is introduced to the suction side of compressor 10 which adds work to the refrigerant and increases both the temperature and the pressure of the refrigerant vapor. This high temperature vapor from the compressor 10 is transported via line 11 to the condenser 20 in which the refrigerant of the present invention, including each of Refrigerants 1-5, supplies heat at a relatively high temperature to the high temperature heat sink, which is represented schematically (but not by way of limitation) by fan 30. The condensed refrigerant of the present invention then is transported by line 21 to a pressure reducing device, such as an expansion valve 40, where the pressure of the liquid refrigerant is reduced, thus producing relatively low temperature liquid refrigerant, which is then introduced via line 21 to the evaporator 50, where the cycle begins again.

The specific type of equipment used in the present heat pump systems can vary widely within the scope of the present invention. For example, the compressor can be of centrifugal, screw and positive displacement type.

With respect to the heat exchangers 50 and 20, applicants note that the preferred refrigerants of the present invention have condenser glides and evaporator glides of from about 4° C. to less than about 15° C. and for the use of the refrigerants of the present invention, including each of Refrigerants 1-5, it is preferred that counter-current and/or cross current flow heat exchangers are used for evaporator(s) and the condenser(s). Applicants have come to appreciate that the use of such heat exchangers in the systems and methods as described herein allow advantageous use of glide matching with the heat sink or heat source. Furthermore, the use of heat exchangers that do not permit fractionation during evaporation or condensation are preferred, and accordingly flooded heat exchangers are preferably not used on the refrigerant side and instead heat exchangers such as brazed plate heat exchangers, and similar heat exchangers which do not permit fractionation of refrigerant, are preferred. For example, if shell and tube heat exchangers are used for either the condenser or the evaporator, it is highly preferred that the refrigerant flows through the tubes in the heat exchanger and not on the shell side. Thus the heat exchangers 20 and 50 of the present systems and methods are preferably a dry expansion or direct expansion type (and not a flooded type) and in the case of the evaporator 50 produce a vapor with a super heat of at least about 5° C. and in the case of the condenser 20 a liquid with subcooling at least about 5° C.

The type of expansion device used can vary. The expansion device can be an expansion valve, which can be electronic or thermostatic as needed by the specifics of the design. This description does not limit any possible additional variances for the specific equipment or the use of additional components that are not illustrated in FIG. 1, such as suction line heat exchangers, vapor ejectors and the like.

The following Table 1 identifies preferred high temperature heat pump methods of the present invention (identified by the HTHP Method numbers in column 1) using the refrigerants of the present invention (identified in column 2 by numbers corresponding to the Refrigerant Numbers defined above), using a direct expansion evaporator and having the operating parameters as specified in the table.

HIGH TEMPERATURE HEAT PUMP METHOD CONDITIONS

| HTHP | | | LTHS | | HTHS. | Performance, | |
|---|---|---|---|---|---|---|---|
| Method | Refrig. | Low Temp. | Temp., | High Temp. | Temp., | %1233zd(E) | |
| No. | No. | Heat Source | ° C. | Heat Sink | ° C. | COP | Capacity |
| 1A | 1A | Industrial | 30-90 | Industrial | 110-145 | =>96 | =>120 |
| | | waste heat | | Steam | | | |
| 1B | 1A | Industrial | 30-90 | Low | 115-130 | =>96 | =>120 |
| | | waste heat | | Pressure | | | |
| | | | | Steam | | | |
| 1C | 1A | Industrial | 30-90 | Hot water | 70-90 | =>96 | =>120 |
| | | waste heat | | | | | |
| 2A | 1A | Industrial | 30-90 | Industrial | 110-145 | =>96 | =>120 |
| | | waste heat | | Steam | | | |
| | | from data | | | | | |
| | | centers | | | | | |
| 2B | 1A | Industrial | 30-90 | Low | 115-130 | =>96 | =>120 |
| | | waste heat | | Pressure | | | |
| | | from data | | Steam | | | |
| | | centers | | | | | |
| 2C | 1A | Industrial | 30-90 | Hot water | 50-70 | =>96 | |
| | | waste heat | | | | | |
| | | from data | | | | | |
| | | centers | | | | | |
| 3A | 1A | Industrial | 30-90 | Industrial | 110-145 | =>96 | =>120 |
| | | waste heat | | Steam | | | |
| | | from data | | | | | |
| | | centers | | | | | |
| 3B | 1A | Industrial | 30-90 | Low | 115-130 | =>96 | =>120 |
| | | waste heat | | Pressure | | | |
| | | from data | | Steam | | | |
| | | centers | | | | | |
| 3C | 1A | Industrial | 30-90 | Hot water | 50-70 | =>96 | =>120 |
| | | waste heat | | | | | |
| | | from data | | | | | |
| | | centers | | | | | |
| 4A | 1A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 4B | 1A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 4C | 1A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 5A | 1A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 5B | 1A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 5C | 1A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 6A | 1A | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 6B | 1A | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 6C | 1A | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 7A | 1B | Industrial | 30-90 | Industrial | 110-145 | =>96 | =>120 |
| | | waste heat | | Steam | | | |
| 7B | 1B | Industrial | 30-90 | Low | 115-130 | =>96 | =>120 |
| | | waste heat | | Pressure | | | |
| | | | | Steam | | | |
| 7C | 1B | Industrial | 30-90 | Hot water | 50-70 | =>96 | =>120 |
| | | waste heat | | | | | |
| 8A | 1B | Industrial | 30-90 | Industrial | 110-145 | =>96 | =>120 |
| | | waste heat | | Steam | | | |
| | | from data | | | | | |
| | | centers | | | | | |
| 8B | 1B | Industrial | 30-90 | Low | 115-130 | =>96 | =>120 |
| | | waste heat | | Pressure | | | |
| | | from data | | Steam | | | |
| | | centers | | | | | |
| 8C | 1B | Industrial | 30-90 | Hot water | 50-70 | =>96 | =>120 |
| | | waste heat | | | | | |
| | | from data | | | | | |
| | | centers | | | | | |
| 9A | 1B | Industrial | 30-90 | Industrial | 110-145 | =>96 | =>120 |
| | | waste heat | | Steam | | | |
| | | from data | | | | | |
| | | centers | | | | | |
| 9B | 1B | Industrial | 30-90 | Low | 115-130 | =>96 | =>120 |
| | | waste heat | | Pressure | | | |
| | | from data | | Steam | | | |
| | | centers | | | | | |
| 9C | 1B | Industrial | 30-90 | Hot water | 50-70 | =>96 | =>120 |
| | | waste heat | | | | | |
| | | from data | | | | | |
| | | centers | | | | | |
| 10A | 1B | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 10B | 1B | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 10C | 1B | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 11A | 1B | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 11B | 1B | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 11C | 1B | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 12A | 1B | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 12B | 1B | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 12C | 1B | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 13A | 1C | Industrial | 30-90 | Industrial | 110-145 | =>96 | =>120 |
| | | waste heat | | Steam | | | |
| 13B | 1C | Industrial | 30-90 | Low | 115-130 | =>96 | =>120 |
| | | waste heat | | Pressure | | | |
| | | | | Steam | | | |
| 13C | 1C | Industrial | 30-90 | Hot water | 50-70 | =>96 | =>120 |
| | | waste heat | | | | | |
| 14A | 1C | Industrial | 30-90 | Industrial | 110-145 | =>96 | =>120 |
| | | waste heat | | Steam | | | |
| | | from data | | | | | |
| | | centers | | | | | |
| 14B | 1C | Industrial | 30-90 | Low | 115-130 | =>96 | =>120 |
| | | waste heat | | Pressure | | | |
| | | from data | | Steam | | | |
| | | centers | | | | | |
| 14C | 1C | Industrial | 30-90 | Hot water | 50-70 | =>96 | =>120 |
| | | waste heat | | | | | |
| | | from data | | | | | |
| | | centers | | | | | |
| 15A | 1C | Industrial | 30-90 | Industrial | 110-145 | =>96 | =>120 |
| | | waste heat | | Steam | | | |
| | | from data | | | | | |
| | | centers | | | | | |
| 15B | 1C | Industrial | 30-90 | Low | 115-130 | =>96 | =>120 |
| | | waste heat | | Pressure | | | |
| | | from data | | Steam | | | |
| | | centers | | | | | |
| 15C | 1C | Industrial | 30-90 | Hot water | 50-70 | =>96 | =>120 |
| | | waste heat | | | | | |
| | | from data | | | | | |
| | | centers | | | | | |
| 16A | 1C | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 16B | 1C | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 16C | 1C | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 17A | 1C | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 17B | 1C | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 17C | 1C | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 17D | 1C | Industrial | 30-90 | Hot air | 35-60 | =>96 | =>120 |
| | | waste heat | | | | | |
| | | from beverage | | | | | |
| | | manufacturing | | | | | |
| | | and/or | | | | | |
| | | processing | | | | | |
| 18A | 1C | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 18B | 1C | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 18C | 1C | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 19A | 2A | Industrial | 30-90 | Industrial | 110-145 | =>96 | =>120 |
| | | waste heat | | Steam | | | |
| 19B | 2A | Industrial | 30-90 | Low | 115-130 | =>96 | =>120 |
| | | waste heat | | Pressure | | | |
| | | | | Steam | | | |
| 19C | 2A | Industrial | 30-90 | Hot water | 50-70 | =>96 | =>120 |
| | | waste heat | | | | | |
| 20A | 2A | Industrial | 30-90 | Industrial | 110-145 | =>96 | =>120 |
| | | waste heat | | Steam | | | |
| | | from data | | | | | |
| | | centers | | | | | |
| 20B | 2A | Industrial | 30-90 | Low | 115-130 | =>96 | =>120 |
| | | waste heat | | Pressure | | | |
| | | from data | | Steam | | | |
| | | centers | | | | | |
| 20C | 2A | Industrial | 30-90 | Hot water | 50-70 | =>96 | =>120 |
| | | waste heat | | | | | |
| | | from data | | | | | |
| | | centers | | | | | |
| 21A | 2A | Industrial | 30-90 | Industrial | 110-145 | =>96 | =>120 |
| | | waste heat | | Steam | | | |
| | | from data | | | | | |
| | | centers | | | | | |
| 21B | 2A | Industrial | 30-90 | Low | 115-130 | =>96 | =>120 |
| | | waste heat | | Pressure | | | |
| | | from data | | Steam | | | |
| | | centers | | | | | |
| 21C | 2A | Industrial | 30-90 | Hot water | 50-70 | =>96 | =>120 |
| | | waste heat | | | | | |
| | | from data | | | | | |
| | | centers | | | | | |
| 22A | 2A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 22B | 2A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 22C | 2A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 23A | 2A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 23B | 2A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 23C | 2A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 24A | 2A | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 24B | 2A | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 24C | 2A | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 25A | 2B | Industrial | 30-90 | Industrial | 110-145 | =>96 | =>120 |
| | | waste heat | | Steam | | | |
| 25B | 2B | Industrial | 30-90 | Low | 115-130 | =>96 | =>120 |
| | | waste heat | | Pressure | | | |
| | | | | Steam | | | |
| 25C | 2B | Industrial | 30-90 | Hot water | 50-70 | =>96 | =>120 |
| | | waste heat | | | | | |
| 26A | 2B | Industrial | 30-90 | Industrial | 110-145 | =>96 | =>120 |
| | | waste heat | | Steam | | | |
| | | from data | | | | | |
| | | centers | | | | | |
| 26B | 2B | Industrial | 30-90 | Low | 115-130 | =>96 | =>120 |
| | | waste heat | | Pressure | | | |
| | | from data | | Steam | | | |
| | | centers | | | | | |
| 26C | 2B | Industrial | 30-90 | Hot water | 50-70 | =>96 | =>120 |
| | | waste heat | | | | | |
| | | from data | | | | | |
| | | centers | | | | | |
| 27A | 2B | Industrial | 30-90 | Industrial | 110-145 | =>96 | =>120 |
| | | waste heat | | Steam | | | |
| | | from data | | | | | |
| | | centers | | | | | |
| 27B | 2B | Industrial | 30-90 | Low | 115-130 | =>96 | =>120 |
| | | waste heat | | Pressure | | | |
| | | from data | | Steam | | | |
| | | centers | | | | | |
| 27C | 2B | Industrial | 30-90 | Hot water | 50-70 | =>96 | =>120 |
| | | waste heat | | | | | |
| | | from data | | | | | |
| | | centers | | | | | |
| 28A | 2B | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 28B | 2B | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 28C | 2B | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 29A | 2B | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 29B | 2B | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 29C | 2B | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 30A | 2B | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 30B | 2B | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 30C | 2B | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 31A | 2C | Industrial | 30-90 | Industrial | 110-145 | =>96 | =>120 |
| | | waste heat | | Steam | | | |
| 31B | 2C | Industrial | 30-90 | Low | 115-130 | =>96 | =>120 |
| | | waste heat | | Pressure | | | |
| | | | | Steam | | | |
| 31C | 2C | Industrial | 30-90 | Hot water | 50-70 | =>96 | =>120 |
| | | waste heat | | | | | |
| 3226A | 2C | Industrial | 30-90 | Industrial | 110-145 | =>96 | =>120 |
| | | waste heat | | Steam | | | |
| | | from data | | | | | |
| | | centers | | | | | |
| 32B | 2C | Industrial | 30-90 | Low | 115-130 | =>96 | =>120 |
| | | waste heat | | Pressure | | | |
| | | from data | | Steam | | | |
| | | centers | | | | | |
| 32C | 2C | Industrial | 30-90 | Hot water | 50-70 | =>96 | =>120 |
| | | waste heat | | | | | |
| | | from data | | | | | |
| | | centers | | | | | |
| 33A | 2C | Industrial | 30-90 | Industrial | 110-145 | =>96 | =>120 |
| | | waste heat | | Steam | | | |
| | | from data | | | | | |
| | | centers | | | | | |
| 33B | 2C | Industrial | 30-90 | Low | 115-130 | =>96 | =>120 |
| | | waste heat | | Pressure | | | |
| | | from data | | Steam | | | |
| | | centers | | | | | |
| 33C | 2C | Industrial | 30-90 | Hot water | 50-70 | =>96 | =>120 |
| | | waste heat | | | | | |
| | | from data | | | | | |
| | | centers | | | | | |
| 34A | 2C | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 34B | 2C | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 34C | 2C | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 35A | 2C | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 35B | 2C | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 35C | 2C | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 36A | 2C | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 36B | 2C | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 36C | 2C | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 37A | 3A | Industrial | 30-90 | Industrial | 110-200 | =>96 | =>120 |
| | | waste heat | | Steam | | | |
| 37B | 3A | Industrial | 30-90 | Low | 115-130 | =>96 | =>120 |
| | | waste heat | | Pressure | | | |
| | | | | Steam | | | |
| 37C | 3A | Industrial | 30-90 | Hot water | 50-70 | =>96 | =>120 |
| | | waste heat | | | | | |
| 38A | 3A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 38B | 3A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 38C | 3A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 39A | 3A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 39B | 3A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 39C | 3A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 40A | 3A | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 40B | 3A | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 40C | 3A | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 41A | 3B | Industrial | 30-90 | Industrial | 110-145 | =>96 | =>120 |
| | | waste heat | | Steam | | | |
| 41B | 3B | Industrial | 30-90 | Low | 115-130 | =>96 | =>120 |
| | | waste heat | | Pressure | | | |
| | | | | Steam | | | |
| 41C | 3B | Industrial | 30-90 | Hot water | 50-70 | =>96 | =>120 |
| | | waste heat | | | | | |
| 42A | 3B | Industrial | 30-90 | Industrial | 110-145 | =>96 | =>120 |
| | | waste heat | | Steam | | | |
| | | from data | | | | | |
| | | centers | | | | | |
| 42B | 3B | Industrial | 30-90 | Low | 115-130 | =>96 | =>120 |
| | | waste heat | | Pressure | | | |
| | | from data | | Steam | | | |
| | | centers | | | | | |
| 42C | 3B | Industrial | 30-90 | Hot water | 50-70 | =>96 | =>120 |
| | | waste heat | | | | | |
| | | from data | | | | | |
| | | centers | | | | | |
| 43A | 3B | Industrial | 30-90 | Industrial | 110-145 | =>96 | =>120 |
| | | waste heat | | Steam | | | |
| | | from data | | | | | |
| | | centers | | | | | |
| 43B | 3B | Industrial | 30-90 | Low | 115-130 | =>96 | =>120 |
| | | waste heat | | Pressure | | | |
| | | from data | | Steam | | | |
| | | centers | | | | | |
| 43C | 3B | Industrial | 30-90 | Hot water | 50-70 | =>96 | =>120 |
| | | waste heat | | | | | |
| | | from data | | | | | |
| | | centers | | | | | |
| 44A | 3B | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 44B | 3B | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 44C | 3B | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 45A | 3B | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 45B | 3B | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 45C | 3B | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 43A | 3C | Industrial | 30-90 | Industrial | 110-145 | =>96 | =>120 |
| | | waste heat | | Steam | | | |
| 43B | 3C | Industrial | 30-90 | Low | 115-130 | =>96 | =>120 |
| | | waste heat | | Pressure | | | |
| | | | | Steam | | | |
| 43C | 3C | Industrial | 30-90 | Hot water | 50-70 | =>96 | =>120 |
| | | waste heat | | | | | |
| 44A | 3C | Industrial | 30-90 | Industrial | 110-145 | =>96 | =>120 |
| | | waste heat | | Steam | | | |
| | | from data | | | | | |
| | | centers | | | | | |
| 44B | 3C | Industrial | 30-90 | Low | 115-130 | =>96 | =>120 |
| | | waste heat | | Pressure | | | |
| | | from data | | Steam | | | |
| | | centers | | | | | |
| 44C | 3C | Industrial | 30-90 | Hot water | 50-70 | =>96 | =>120 |
| | | waste heat | | | | | |
| | | from data | | | | | |
| | | centers | | | | | |
| 45A | 3C | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 45B | 3C | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 45C | 3C | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 46A | 3C | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 46B | 3C | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 46C | 3C | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 47A | 4A | Industrial | 30-90 | Industrial | 110-145 | =>96 | =>120 |
| | | waste heat | | Steam | | | |
| 47B | 4A | Industrial | 30-90 | Low | 115-130 | =>96 | =>120 |
| | | waste heat | | Pressure | | | |
| | | | | Steam | | | |
| 47C | 4A | Industrial | 30-90 | Hot water | 50-70 | =>96 | =>120 |
| | | waste heat | | | | | |
| 48A | 4A | Industrial | 30-90 | Industrial | 110-145 | =>96 | =>120 |
| | | waste heat | | Steam | | | |
| | | from data | | | | | |
| | | centers | | | | | |
| 48B | 4A | Industrial | 30-90 | Low | 115-130 | =>96 | =>120 |
| | | waste heat | | Pressure | | | |
| | | from data | | Steam | | | |
| | | centers | | | | | |
| 48C | 4A | Industrial | 30-90 | Hot water | 50-70 | =>96 | =>120 |
| | | waste heat | | | | | |
| | | from data | | | | | |
| | | centers | | | | | |
| 49A | 4A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 49B | 4A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 49C | 4A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 50A | 4A | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 50B | 4A | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 50C | 4A | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 51A | 4B | Industrial | 30-90 | Industrial | 110-145 | =>96 | =>120 |
| | | waste heat | | Steam | | | |
| 51B | 4B | Industrial | 30-90 | Low | 115-130 | =>96 | =>120 |
| | | waste heat | | Pressure | | | |
| | | | | Steam | | | |
| 51C | 4B | Industrial | 30-90 | Hot water | 50-70 | =>96 | =>120 |
| | | waste heat | | | | | |
| 52A | 4B | Industrial | 30-90 | Industrial | 110-145 | =>96 | =>120 |
| | | waste heat | | Steam | | | |
| | | from data | | | | | |
| | | centers | | | | | |
| 52B | 4B | Industrial | 30-90 | Low | 115-130 | =>96 | =>120 |
| | | waste heat | | Pressure | | | |
| | | from data | | Steam | | | |
| | | centers | | | | | |
| 52C | 4B | Industrial | 30-90 | Hot water | 50-70 | =>96 | =>120 |
| | | waste heat | | | | | |
| | | from data | | | | | |
| | | centers | | | | | |
| 53A | 4B | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 53B | 4B | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 53C | 4B | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 54A | 4B | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 54B | 4B | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 54C | 4B | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 55A | 5A | Industrial | 30-90 | Industrial | 110-145 | =>96 | =>120 |
| | | waste heat | | Steam | | | |
| 55B | 5A | Industrial | 30-90 | Low | 115-130 | =>96 | =>120 |
| | | waste heat | | Pressure | | | |
| | | | | Steam | | | |
| 55C | 5A | Industrial | 30-90 | Hot water | 50-70 | =>96 | =>120 |
| | | waste heat | | | | | |
| 56A | 5A | Industrial | 30-90 | Industrial | 110-145 | =>96 | =>120 |
| | | waste heat | | Steam | | | |
| | | from data | | | | | |
| | | centers | | | | | |
| 56B | 5A | Industrial | 30-90 | Low | 115-130 | =>96 | =>120 |
| | | waste heat | | Pressure | | | |
| | | from data | | Steam | | | |
| | | centers | | | | | |
| 56C | 5A | Industrial | 30-90 | Hot water | 50-70 | =>96 | =>120 |
| | | waste heat | | | | | |
| | | from data | | | | | |
| | | centers | | | | | |
| 57A | 5A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 57B | 5A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 57C | 5A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 58A | 5A | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 58B | 5A | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 58C | 5A | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 59A | 5A | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 59B | 5A | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 59C | 5A | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |
| 60A | 5B | Industrial | 30-90 | Industrial | 110-145 | =>96 | =>120 |
| | | waste heat | | Steam | | | |
| 60B | 5B | Industrial | 30-90 | Low | 115-130 | =>96 | =>120 |
| | | waste heat | | Pressure | | | |
| | | | | Steam | | | |
| 60C | 5B | Industrial | 30-90 | Hot water | 50-70 | =>96 | =>120 |
| | | waste heat | | | | | |
| 61A | 5B | Industrial | 30-90 | Industrial | 110-145 | =>96 | =>120 |
| | | waste heat | | Steam | | | |
| | | from data | | | | | |
| | | centers | | | | | |
| 61B | 5B | Industrial | 30-90 | Low | 115-130 | =>96 | =>120 |
| | | waste heat | | Pressure | | | |
| | | from data | | Steam | | | |
| | | centers | | | | | |
| 61C | 5B | Industrial | 30-90 | Hot water | 50-70 | =>96 | =>120 |
| | | waste heat | | | | | |
| | | from data | | | | | |
| | | centers | | | | | |
| 62A | 5B | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 62B | 5B | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 62C | 5B | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 63A | 5B | Industrial | 30-90 | Industrial | 110-145 | =>96 | =>120 |
| | | waste heat | | Steam | | | |
| | | from beverage | | | | | |
| | | manufacturing | | | | | |
| | | and/or | | | | | |
| | | bottling | | | | | |
| 63B | 5B | Industrial | 30-90 | Low | 115-130 | =>96 | =>120 |
| | | waste heat | | Pressure | | | |
| | | from beverage | | Steam | | | |
| | | manufacturing | | | | | |
| | | and/or | | | | | |
| | | bottling | | | | | |
| 63C | 5B | Industrial | 30-90 | Hot water | 50-70 | =>96 | =>120 |
| | | waste heat | | | | | |
| | | from beverage | | | | | |
| | | manufacturing | | | | | |
| | | and/or | | | | | |
| | | bottling | | | | | |
| 64A | 5B | Industrial | 30-90 | Industrial | 110-145 | =>96 | =>120 |
| | | waste heat | | Steam | | | |
| | | from dairy | | | | | |
| | | manufacturing | | | | | |
| | | and/or | | | | | |
| | | processing | | | | | |
| 64B | 5B | Industrial | 30-90 | Low | 115-130 | =>96 | =>120 |
| | | waste heat | | Pressure | | | |
| | | from dairy | | Steam | | | |
| | | manufacturing | | | | | |
| | | and/or | | | | | |
| | | processing | | | | | |
| 64C | 5B | Industrial | 30-90 | Hot water | 50-70 | =>96 | =>120 |
| | | waste heat | | | | | |
| | | from dairy | | | | | |
| | | manufacturing | | | | | |
| | | and/or | | | | | |
| | | processing | | | | | |

Applicants have found that the refrigerant compositions of the present invention, including each of Refrigerants 1-5, are able to satisfy in an exceptional and unexpected way the need for HTHP systems having excellent performance with respect to environmental impact while at the same time providing other important performance characteristics, such as, but not limited to, high capacity and efficiency, flammability that is Class 1 or 2 L, and acceptable toxicity.

In preferred embodiments the present compositions, including each of Refrigerants 1-5, provide alternatives and/or replacements for working fluids currently used in high temperature heat pump applications, particularly and preferably as alternatives and/or replacements for CFC-114 and R-1233zd(E).

In preferred embodiments, each of the methods of the present invention, including Heat Transfer Method 1 and HTHP Methods 1-64, utilizes a refrigerant of the present invention, including each of Refrigerants 1-5, wherein the critical temperature of the refrigerant is greater than the temperature of the high temperature heat sink.

In preferred embodiments, each of the methods of the present invention, including Heat Transfer Method 1 and HTHP Methods 1-64, utilizes a refrigerant of the present invention, including each of Refrigerants 1-5, wherein the critical temperature of the refrigerant is greater than the temperature of the high temperature heat sink and wherein the refrigerant critical temperature is about 160° C. or less.

### Heat Transfer Compositions

The compositions of the present invention are those which include refrigerants of the present invention, including each of Refrigerants 1-5. Applicants have found that use of the components of the present invention within the stated ranges is important to achieve the important but difficult to achieve combinations of properties exhibited by the present compositions, particularly in the preferred HTHP systems and methods.

The compositions of the present invention are those which include refrigerants of the present invention, including each of Refrigerants 1-5, having a critical temperature of 160° C. or less.

The heat transfer compositions of the present invention may include, in addition to the present refrigerants, other components for the purpose of enhancing or providing certain functionality to the heat transfer composition, or in some cases to reduce the cost of the composition. For example, heat transfer compositions which include the present refrigerants, including Refrigerants 1-5, when used in the preferred vapor compression HTHP systems, will also generally include one or more lubricants. The amount of the lubricant in the heat transfer composition can vary even within the HTHP system, generally in amounts of from as little as 0.1 percent by weight to up to about 20 percent by weight. For a given system, the relative amount of the lubricant present in the system as a percentage of the total amount of lubricant and refrigerant in system can also vary widely, such as from about 30 to about 50 percent by weight.

Applicants have found that Polyol Esters (POEs) and Poly Vinyl Ethers (PVEs), PAG oils, silicone oil, lubricants that have been used in refrigeration machinery with previously used hydrofluorocarbon (HFC) refrigerants may, in certain embodiments, be used to advantage in the heat transfer compositions and in the HTHP systems and methods of the present invention. Commercially available esters include neopentyl glycol dipelargonate, which is available as Emery 2917 (registered trademark) and Hatcol 2370 (registered trademark). Other useful esters include phosphate esters, dibasic acid esters, and fluoroesters. Preferred lubricants include POEs and PVEs. Of course, different mixtures of different types of lubricants may be used.

### Heat Transfer Methods and Systems

The present methods, systems and compositions are thus adaptable for use in connection with a wide variety of heat transfer systems in general and HTHP systems in particular. The preferred high temperature heat pump systems include those in which the refrigerants of the present invention condense at a temperature of greater than 90° C., and even more preferably greater than about 100° C. Examples of such systems include, but are not limited to those used as replacements for boilers by the industry, district heating heat pumps (including shallow geothermal district heating systems), and commercial heat pumps. Examples include water-to-water heat pumps for shopping centers. They can also be used in the oil or mining industry where heat source is readily available. The compressor is usually of centrifugal type and screw type, but other types like scroll may also be used. The heat exchangers can be direct expansion shell-tube type (preferably with the refrigerant on the tube-side) and brazed plate heat exchanger. The heat pump systems of the present invention may also include in preferred embodiments an economizer with vapor injection and suction line heat exchangers.

As mentioned above, the present invention achieves exceptional advantages in connection with heat pump systems, including particularly and preferably high temperature heat pump systems. Non-limiting examples of such systems are provided in the Examples below. The examples below provide typical conditions and parameters for certain high temperature heat pumps but do not limit the broad scope of the operation of the systems and methods of the present invention. To this end, the conditions used in the examples are generally representative of but are not considered limiting of the invention, as one of skill in the art will appreciate that they may be varied based on one or more of a myriad of factors, including but not limited to, ambient conditions, intended application, time of year, and the like. Such examples are also not necessarily limiting to the definition of the term “high temperature heat pump system.”

It is contemplated that in certain embodiments the present invention provides methods of reducing the cost of providing a high temperature heat pump by replacing at least a substantial portion of the heat transfer fluid (including the refrigerant and optionally the lubricant) in an existing system with a refrigerant of the present invention, including each of Refrigerants 1-5, One advantage of the present replacement methods is the ability to achieve a reduced cost for the system as a result of the ability to use in the same application a compressor having a substantially reduced displacement compared to previously used refrigerants, including particularly 1233zd(E). In certain preferred embodiments the compressor displacement is about 90% or less than the displacement required to achieve in the system the same capacity using 1233zd(E), preferably 85% or less than the displacement required to achieve in the system the same capacity using 1233zd(E), even more preferably at least about preferably 80% or less than the displacement required to achieve in the system the same capacity using 1233zd(E).

### EXAMPLES

The following examples are provided for the purpose of illustrating the present invention but without limiting the scope thereof.

### Comparative Example 1

A HTHP system is operated with a refrigerant consisting of 1233zd(E) under the following operating conditions:
1. Heat Sink Temperature=100° C.
2. Heat Source Temperature=25° C.
3. Refrigerant Condensing temperature=130° C.
4. Condenser sub-cooling=5.0° C.
5. Refrigerant Evaporating temperature=60° C.
6. Evaporator Superheat=5.0° C.
7. Isentropic Efficiency=65%
8. Volumetric Efficiency=95%
   The HTHP system is operated, and the coefficient of performance (COP) and capacity of the system are determined (based on the pressure drop and heat transfer in the connecting lines (suction and liquid lines) considered to be negligible, and heat leakage through the compressor shell being ignored). COP is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration to the energy applied by the compressor in compressing the vapor. The capacity of a refrigerant represents the amount of cooling or heating it provides and provides some measure of the capability of a compressor to pump quantities of heat for a given volumetric flow rate of refrigerant and other operating conditions. In other words, given a specific compressor and set of operating conditions, a refrigerant with a higher capacity will deliver more cooling or heating power. One means for estimating COP and capacity of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988).

For the purposes of comparison, the COP and capacity of the HTHP operated as in this Comparative Example 1 using a refrigerant consisting of 1233zd(E) is set as the base line and referred to in the following example as having a base line with a value of 100% for COP and volumetric capacity.

### Examples 1A1-1A12

Twelve refrigerants according to the present invention are formed in accordance with the blends identified as A1-A12 in Table Ex1A below, and each refrigerant is found to have the burning velocity (“BV”) and global warming potential (“GWP)” determined in accordance with the Definitions above and as reported in the table below:

TABLE Ex1A

| | Components | | | | | |
|---|---|---|---|---|---|---|
| | R152a | | R1234ze(E) | | | |
| | (wt %) | R1233zd(E) | (wt %) | | | |
| | CT - | (wt %) | CT | | Properties | |
| Refrigerant | 113.3 C. | CT - 160 C. | 153.7 C. | Total | BV | GWP |
| A1 | 2.3% | 82.8% | 14.9% | 100% | 4.4 | <15 |
| A2 | 3.0% | 82.9% | 14.1% | 100% | 5.1 | <15 |
| A3 | 3.0% | 83% | 14.0% | 100% | 5.1 | <15 |
| A4 | 4.0% | 83.1% | 12.9% | 100% | 6.4 | <15 |
| A5 | 4.0% | 85% | 11% | 100 | 6.5 | <15 |
| A6 | 5.0% | 83.2% | 11.8% | 100% | 7.5 | <15 |
| A7 | 5.0% | 86.0% | 9.0% | 100% | 7.8 | <15 |
| A8 | 6.0% | 83.4% | 10.6% | 100% | 8.6 | <15 |
| A9 | 6.0% | 88% | 6.0% | 100% | 9.2 | <15 |
| A10 | 7.0% | 83.5% | 9.5% | 100% | 9.6 | <15 |
| A11 | 6.7% | 88.7% | 4.6% | 100% | 9.4 | <15 |
| A12 | 7.4% | 83.6% | 9.0% | 100% | 9.4 | <15 |
| A13 | 8.4% | 82.6% | 9.0% | 100% | 10.0 | <15 |

As can be seen from the table above, applicants have found that each of refrigerants A1-A13 has not only a GWP of less than 15 but also a burning velocity of 10 cm/s (3.94 in/s) or less, and is therefore a Class 2 L refrigerant.

Each of the refrigerants A1-A13 is then utilized in the same high temperature heat pump as described in and under the same operating conditions as specified in Comparative Example 1. The following results in terms of COP and Capacity for the conditions specified above are determined and reported in Table Ex1B below:

TABLE X1B

| | | Operating Performance | |
|---|---|---|---|
| | Refrigerant | Relative to 1233zd(E) | |
| Example | (wt %152a/1233zd(E)/ | CAPACITY | COP |
| No. | 1234ze(E) | (%1233ZD(E)) | (%1233ZD(E)) |
| Ex1A1 | A1 (2.3/82.8/14.9) | 120% | 96.0% |
| Ex1A2 | A2 (3.0/82.9/14.1) | 120% | 96.0% |
| Ex1A3 | A3 (3.0/83.0/14.0) | 120% | 96.0% |
| Ex1A4 | A4 (4.0/83.1/12.9) | 121% | 96.0% |
| Ex1A5 | A5 (4.0/85/11) | 120% | 96.5% |
| Ex1A6 | A6 (5.0/83.2/11.8) | 123% | 96.0% |
| Ex1A7 | A7 (5.0/86/9) | 120% | 96.7% |
| Ex1A8 | A8 (6.0/83.4/10.6) | 124% | 96.0% |
| Ex1A9 | A9 (6.0/88.0/6.0) | 123% | 97.2% |
| Ex1A10 | A10 (7.0/83.5/9.5) | 125% | 96.0% |
| Ex1A11 | A11 (6.7/88.7/4.6) | 125% | 97.3% |
| Ex1A12 | A12 (7.4/83.6/9.0) | 125% | 96.0% |
| Ex1A13 | A13(8.4/82.6/9.0) | 127% | 96.0% |

As can be seen from the Tables above, each of the refrigerants A1-A12 of the present invention is unexpectedly able to at once achieve a GWP of less than 15, a Class 2 L flammability designation and to operate in a HTHP with a COP that is above 96% and a capacity that is 120% or greater than the capacity of 1233z(E) in the same HTHP system and operating under the same set of specified conditions. Preferred compositions are A5, A7, A9 and A11 since each of those refrigerants has a burning velocity that is less than 10 cm/s and at the same time achieves either a COP of greater than 96% or a Capacity of 120% or greater. Especially preferred compositions are A7, A9 and A11 since each of those refrigerants has a burning velocity that is less than 10 cm/s and at the same time achieves COP of greater than 96% and a capacity of greater than 120%. Refrigerant composition A6 is preferred in view of its ability to achieve a burning velocity that is less than 8 cm/s and at the same time achieve a capacity of greater than 122%, and refrigerant composition A7 is preferred in view of its ability to achieve a burning velocity that is less than 8 cm/s and at the same time achieve a COP of greater than 96%.

### Examples 2A1-2A3

The HTHP system of Comparative Example 1 is operated as in Comparative Example 1, except with three refrigerant blends as indicated in the following Table Ex2A.

TABLE Ex2

| | | | | | Performance | |
|---|---|---|---|---|---|---|
| | Refrigerant Components | | | | Properties | |
| | R152a | R1233zd(E) | R1234ze(E) | | (Rel. to 1233zd(E)) | |
| Example C2 | (wt %) | (wt %) | (wt %) | Total | Capacity | COP |
| Ex2A | 0.0% | 82.6% | 17.4% | 100% | 117% | 96.0% |
| Ex2B | 1.0% | 82.7% | 16.3% | 100% | 118% | 96.0% |
| Ex2C | 2.0% | 82.8% | 15.2% | 100% | 119% | 96.0% |

As shown in the results of this Example 2, applicants have surprisingly found that while refrigerants comprising 2% or less by weight of HFC-152a are able to achieve COP values of 96%, the tested refrigerants were found to not achieve the preferred capacity of 120% or greater.

### Examples 3A, 3B and 3C

The HTHP system of Comparative Example 1 is operated as in Comparative Example 1, except with refrigerant blends as identified in the following Table Ex3 were used. These refrigerants were tested for flammability and performance, and the results are reported in the following Table Ex3.

TABLE Ex3

| | | | | | | | Performance | |
|---|---|---|---|---|---|---|---|---|
| | | | | | | | Properties | |
| | Refrigerant Components | | | | | | (Rel. to | |
| | R152a | R1233zd(E) | R1234ze(E) | | Flammability | | 1233zd(E)) | |
| Example 3 | (wt %) | (wt %) | (wt %) | Total | BV | LFL | Capacity | COP |
| Ex3A | 8.0% | 83.7% | 8.3% | 100% | 10.5 | 0.37 | 126% | 96.0% |
| Ex3B | 7.0% | 89% | 4% | 100% | 10.4 | 0.4 | 120% | 97.4% |
| Ex3C | 8.0% | 90% | 2% | 100% | 11.6 | 0.36 | 120% | 97.6% |

As shown in the results of this Example 3A-3C, applicants have surprisingly found that while each of the refrigerant blends Ex3A, Ex3B and Ex3C is able to achieve the desirable COP and Capacity performance of the most preferred refrigerants of the present invention, applicants have found none of these refrigerants able to be classified as 2 L since each has a burning velocity above 10.

### Comparative Example 2—Use of R-1233ZD(E) in Industrial High Temperature Heat Pumps with a Heat Source Temperature of Above 60° C. and Refrigerant Condensing Temperature of 130° C.

An industrial heat pump system having a basic structure as illustrated in FIG. 1 is provided and is used to supply heat for an industrial process heat in the form of direct heating, heating a secondary fluid or by generating steam. This system uses residual heat from another process or waste heat at temperatures above 60° C. as the heat source for its evaporator and provides heat to a heat sink at a temperature of from about 90° C.-135° C. The system is operated under the following conditions using R-1233zd(E) as the refrigerant:
1. Refrigerant condensing temperature=130° C.
2. Condenser sub-cooling=5° C.
3. Refrigerant evaporating temperature=60° C.
4. Evaporator Superheat=5° C.
5. Isentropic Efficiency=65%
6. Volumetric Efficiency=100%
   The system performance under these conditions is used as the baseline for Examples 4A and 4B below (i.e., values of heating capacity, compressor pressure ratio, compressor displacement and discharge pressure are set as a baseline of 100% for comparison purposes, and discharge temperature difference is reported relative the discharge temperature of this Comparative Example 2).

### Examples 4A and 4B: Use of Inventive Refrigerants A14 and A15 Comprising R-152a, R-11233zd(E) and R-1234Ze(E) for Industrial High Temperature Heat Pumps with a Heat Source Temperature of 60° C. and Refrigerant Condensing Temperature of 130° C.

Comparative Example 2 is repeated except that the refrigerants A14 and A15 identified in Table E4A below are used to produce the results reported in Table E4B, together with the results from Comparative Example 1 for ease of comparison:

TABLE E4A

| | Composition | | | | |
|---|---|---|---|---|---|
| | | R- | | Properties | |
| Refrigerant | R-152a | 1233zd(E) | R1234ze(E) | Boiling | Critical |
| Designation | (wt. %) | (wt. %) | (wt. %) | Point, ° C. | Temperature, ° C. |
| A14 | 5.0 | 86.2 | 8.8 | 1.6 | 156.1 |
| A15 | 5.0 | 83.2 | 11.8 | 0.2 | 154.3 |

TABLE E4B

| | | | | | Discharge | | |
|---|---|---|---|---|---|---|---|
| | | | | | Temperature | Evaporator | Condenser |
| | Heating | Heating | Pressure | Discharge | Difference | Glide | Glide |
| Refrigerant | Capacity | Efficiency | ratio | Pressure | [° C.] | [° C.] | [° C.] |
| R- | 100% | 100% | 100% | 100% | 0 | 0 | 0 |
| 1233zd(E) | | | | | | | |
| A14 | 120% | 97% | 103% | 126% | 6.3 | 2.79 | 5.98 |
| A15 | 123% | 96% | 102% | 130% | 6.8 | 3.10 | 6.30 |

As can be seen from the results in Tables E4A and E4B, refrigerants of the present invention A14 and A15 provide 20-23% greater heating capacity than R-1233zd(E) while displaying minimal losses in efficiency of only 3-4%. This would allow the possible use of compressor displacement that is only about 80-85% of the displacement needed for Comparative Example 2, thus providing the possibility of substantial savings in the cost of the system and/or its ongoing maintenance. Both refrigerants also have minor increases in discharge pressure and pressure ratios, which would possibly allow for the same compressor design as used for R-1233zd(E). The discharge pressure is 26-30% greater than R-1233zd(E), however since R-1233zd(E) is already a low-pressure refrigerant and since A14 and A15 have boiling points much lower than R-1233zd(E), the inventive refrigerants would operate above atmospheric pressure at these temperatures.

### Comparative Example 3—Use of r-1233ZD (E) in Industrial High Temperature Heat Pumps with a Heat Source Temperature of Above 30° C. and Refrigerant Condensing Temperature of 130° C.

Comparative Example 2 is repeated, except the heat source temperature is about 30° C. and the following system conditions are changed as indicated below:
a. Refrigerant evaporating temperature=30° C.
b. Isentropic Efficiency=60%
   The system performance under these conditions is used as the baseline for Examples 5A and 5B below (i.e., values of heating capacity, compressor pressure ratio, compressor displacement and discharge pressure are set as a baseline of 100% for comparison purposes, and discharge temperature difference is reported relative the discharge temperature of this Comparative Example 3).

### Examples 5A-5B: Use of Refrigerant Comprising R-152a, R-1233zd(E) and R-1234Ze(E) for Industrial High Temperature Heat Pumps with a Heat Source Temperature of Above 30° C. and Refrigerant Condensing Temperature of 130° C.

Comparative Example 3 is repeated except that the refrigerants identified in Table E4A above are used to produce the results reported in Table E5 below, together with the results from Comparative Example 3 for ease of comparison:

TABLE E5

| | | | | | Discharge | | |
|---|---|---|---|---|---|---|---|
| | | | | | Temperature | Evaporator | Condenser |
| | Heating | Heating | Pressure | Discharge | Difference | Glide | Glide |
| Refrigerant | Capacity | Efficiency | ratio | Pressure | [° C.] | [° C.] | [° C.] |
| R- | 100% | 100% | 100% | 100% | 0 | 0 | 0 |
| 1233zd(E) | | | | | | | |
| A14 | 120% | 97% | 103% | 126% | 7.2 | 1.60 | 5.98 |
| A15 | 123% | 97% | 103% | 130% | 7.6 | 1.80 | 6.30 |

As can be seen from the results in Table E5, refrigerants of the present invention A14 and A15 provide 20-23% greater heating capacity than R-1233zd(E) while displaying minimal losses in efficiency of only 3%. This would allow the possible use of compressor displacement that is only about 80-85% of the displacement needed for Comparative Example 2, thus providing the possibility of substantial savings in the cost of the system and/or its ongoing maintenance. Both refrigerants also have minor increases in discharge pressure and pressure ratios, which would possibly allow for the same compressor design as used for R-1233zd(E). The discharge pressure is 26-30% greater than R-1233zd(E), however since R-1233zd(E) is already a low-pressure refrigerant and since A14 and A15 have boiling points much lower than R-1233zd(E), the inventive refrigerants would operate above atmospheric pressure at these temperatures.

### Comparative Example 4—Use of R-1233ZD (E) in Industrial High Temperature Heat Pumps with a Heat Source Temperature of Above 60° C. and Refrigerant Condensing Temperature of 90° C.

An industrial heat pump system having a basic structure as illustrated in FIG. 1 is provided and is used to supply heat for an industrial process heat in the form of direct heating, heating a secondary fluid or by generating steam. This system uses residual heat from another process or waste heat at temperatures above 60° C. as the heat source for its evaporator. The system is operated under the following conditions using R-1233zd(E) as the refrigerant:
a. Refrigerant condensing temperature=90° C.
b. Condenser sub-cooling=5° C.
c. Refrigerant evaporating temperature=60° C.
d. Evaporator Superheat=5° C.
e. Isentropic Efficiency=70%
f. Volumetric Efficiency=100%
   The system performance under these conditions is used as the baseline for Examples 6A and 6B below (i.e., values of heating capacity, compressor pressure ratio, compressor displacement and discharge pressure are set as a baseline of 100% for comparison purposes, and discharge temperature difference is reported relative the discharge temperature of this Comparative Example 4).

### Examples 6A and 6B: Use of Inventive Refrigerants A13 and A14 Comprising R-152a, R-11233zd(E) and R-1234Ze(E) for Industrial High Temperature Heat Pumps with a Heat Source Temperature of 60° C. and Refrigerant Condensing Temperature of 90° C.

Comparative Example 4 is repeated except that the refrigerants A14 and A15 identified in Table E4A above are used to produce the results reported in Table E6 below, together with the results from Comparative Example 4 for ease of comparison:

TABLE E6

| | | | | | Discharge | | |
|---|---|---|---|---|---|---|---|
| | | | | | Temperature | Evaporator | Condenser |
| | Heating | Heating | Pressure | Discharge | Difference | Glide | Glide |
| Refrigerant | Capacity | Efficiency | ratio | Pressure | [° C.] | [° C.] | [° C.] |
| R- | 100% | 100% | 100% | 100% | 0 | 0 | 0 |
| 1233zd(E) | | | | | | | |
| A14 | 129% | 99% | 101% | 130% | 5.4 | 6.77 | 8.71 |
| A15 | 133% | 99% | 100% | 135% | 5.7 | 7.39 | 9.27 |

As can be seen from the results in Table E6, refrigerants of the present invention A14 and A15 provide 29-33% greater heating capacity than R-1233zd(E) while displaying minimal losses in efficiency of only 1%. This would allow the possible use of compressor displacement that is only about 75-80% of the displacement needed for Comparative Example 4 thus providing the possibility of substantial savings in the cost of the system and/or its ongoing maintenance. Both refrigerants also have minor increases in discharge pressure and pressure ratios, which would possibly allow for the same compressor design as used for R-1233zd(E). The discharge pressure is 30-35% greater than R-1233zd(E), however since R-1233zd(E) is already a low-pressure refrigerant and since A14 and A15 have boiling points much lower than R-1233zd(E), the inventive refrigerants would operate above atmospheric pressure at these temperatures.

### Comparative Example 5—Use of R-1233ZD (E) in Industrial High Temperature Heat Pumps with a Heat Source Temperature of Above 30° C. and Refrigerant Condensing Temperature of 90° C.

Comparative Example 4 is repeated, except the heat source temperature is about 30° C. and the following system conditions are changed as indicated below:
a. Refrigerant evaporating temperature=30° C.
b. Isentropic Efficiency=65%
   The system performance under these conditions is used as the baseline for Examples 7A and 7B below (i.e., values of heating capacity, compressor pressure ratio, compressor displacement and discharge pressure are set as a baseline of 100% for comparison purposes, and discharge temperature difference is reported relative the discharge temperature of this Comparative Example 5).

### Examples 7A-7B: Use of Refrigerant Comprising R-152a, R-11233zd(E) and R-1234ze(E) for Industrial High Temperature Heat Pumps with a Heat Source Temperature of Above 30° C. and Refrigerant Condensing Temperature of 90° C.

Comparative Example 5 is repeated except that the refrigerants identified in Table E4A above are used to produce the results reported in Table E7 below, together with the results from Comparative Example 5 for ease of comparison:

TABLE E7

| | | | | | Discharge | | |
|---|---|---|---|---|---|---|---|
| | | | | | Temperature | Evaporator | Condenser |
| | Heating | Heating | Pressure | Discharge | Difference | Glide | Glide |
| Refrigerant | Capacity | Efficiency | ratio | Pressure | [° C.] | [° C.] | [° C.] |
| R- | 100% | 100% | 100% | 100% | 0 | 0 | 0 |
| 1233zd(E) | | | | | | | |
| A14 | 128% | 99% | 102% | 130% | 6.3 | 4.50 | 8.71 |
| A15 | 132% | 99% | 101% | 135% | 6.6 | 5.05 | 9.27 |

As can be seen from the results in Table E7, refrigerants of the present invention A14 and A15 provide 28-32% greater heating capacity than R-1233zd(E) while displaying minimal losses in efficiency of only 1%. This would allow the possible use of compressor displacement that is only about 80-85% of the displacement needed for Comparative Example 2, thus providing the possibility of substantial savings in the cost of the system and/or its ongoing maintenance. Both refrigerants also have minor increases in discharge pressure and pressure ratios, which would possibly allow for the same compressor design as used for R-1233zd(E). The discharge pressure is 30-35% greater than R-1233zd(E), however since R-1233zd(E) is already a low-pressure refrigerant and since A14 and A15 have boiling points much lower than R-1233zd(E), the inventive refrigerants would operate above atmospheric pressure at these temperatures.

### Comparative Example 6: Use of Refrigerant R-1234Ze(E) for Comfort Cooling or Chillers

A chiller system having a basic structure as illustrated in FIG. 1, is provided, and is used to supply chilled water for comfort cooling. The system is operated under the following conditions using R-1234ze(E) as the refrigerant:
1. Refrigerant condensing temperature=45° C.
2. Condenser sub-cooling=5° C.
3. Refrigerant evaporating temperature=10° C.
4. Evaporator Superheat=5° C.
5. Isentropic Efficiency=75%
6. Volumetric Efficiency=100%
   The system performance under these conditions is used as the baseline for Examples 8A and 8B (i.e., values of cooling capacity, compressor pressure ratio, and discharge pressure are set as a baseline of 100% for comparison purposes, and discharge temperature difference is reported relative the discharge temperature of this example).

### Examples 8A-8B: Use of Refrigerant Comprising R-152a, R-1233zd(E) and R-1234ze(E) for Comfort Cooling or Chillers with Refrigerant Condensing Temperature of 45° C. and Refrigerant Evaporating Temperature of 10° C.

Comparative Example 6 is repeated except that the refrigerants identified in Table E4A above are used to produce the results reported in Table E8 below, together with the results from Comparative Example 6 for ease of comparison:

TABLE E7

| | | | | | Discharge | | |
|---|---|---|---|---|---|---|---|
| | | | | | Temperature | Evaporator | Condenser |
| | Heating | Heating | Pressure | Discharge | Difference | Glide | Glide |
| Refrigerant | Capacity | Efficiency | ratio | Pressure | [° C.] | [° C.] | [° C.] |
| R- | 100% | 100% | 100% | 100% | 0 | 0 | 0 |
| 1234ze(E) | | | | | | | |
| A14 | 42% | 104% | 121% | 40% | 8.2 | 7.70 | 10.73 |
| A15 | 44% | 105% | 120% | 42% | 8.5 | 8..45 | 11.37 |

As can be seen from the results in Table E8, refrigerants of the present invention A14 and A15 provide a heating capacity that is only 42-44% of the heating capacity than R-1234ze(E), but at the same time an efficiency that is 4-5% greater than R-1234ze(E). The use of the inventive refrigerants A14 and A15 in this application would be preferred when efficiency is prioritized over capacity.

What is claimed is:

1. A refrigerant comprising at least about 95% by weight based on the total of all refrigerants of the following three components in the following relative concentrations:
(1) from about 83% to about 89% by weight of HFO-1233zd(E);
(2) from 4.6% to about 15% by weight of HFO-1234ze(E); and
(3) from about 2% to 7.4% by weight of HFC-152a.

2. The refrigerant of claim 1 consisting essentially of:
(1) from about 83% to about 89% by weight of HFO-1233zd(E);
(2) from 4.6% to about 15% by weight of HFO-1234ze(E); and
(3) from about 2% to 7.4% by weight of HFC-152a.

3. The refrigerant of claim 2 consisting of said HFO-1233zd(E), said HFO-1234ze(E) and said HFC-152a.

4. The refrigerant of claim 1 wherein said refrigerant has a burning velocity (BV) of 10 cm/s or less.

5. The refrigerant of claim 1 wherein said refrigerant has a burning velocity (BV) of 8 cm/s or less.

6. The refrigerant of claim 1 wherein said refrigerant has a burning velocity (BV) of 6 cm/s or less.

7. The refrigerant of claim 1 wherein said refrigerant has a GWP of 15 or less.

8. The refrigerant of claim 1 wherein said refrigerant has a GWP of 10 or less.

9. The refrigerant of claim 1 comprising at least about 95% by weight based on the total of all refrigerants of the following three components in the following relative concentrations:
(1) from about 83% to about 86% by weight of HFO-1233zd(E);
(2) from 4.6% to 15% by weight of HFO-1234ze(E); and
(3) from 2% to 7.4% by weight of HFC-152a.

10. The refrigerant of claim 1 comprising at least about 95% by weight based on the total of all refrigerants of the following three components in the following relative concentrations:
(1) from about 83% to about 86% by weight of HFO-1233zd(E);
(2) from about 6% to 13% by weight of HFO-1234ze(E); and
(3) from 4% to 6% by weight of HFC-152a.

11. The refrigerant of claim 1 having an OEL greater than 400.

12. The refrigerant of claim 1 having a critical temperature of 150° C. or greater.

13. The refrigerant of claim 1 consisting essentially of the following three components in the following relative concentrations:
(1) 86.2%+/−2% by weight of HFO-1233zd(E);
(2) 8.8%+/−1% by weight of HFO-1234ze(E); and
(3) 5%+/−1% by weight of HFC-152a.

14. The refrigerant of claim 1 consisting essentially of the following three components in the following relative concentrations:
(1) 83.2%+/−2% by weight of HFO-1233zd(E);
(2) 11.8%+/−1% by weight of HFO-1234ze(E); and
(3) 5%+/−1% by weight of HFC-152a.

15. A method of producing heat in a high temperature heat pump comprising compressing and evaporating in a direct expansion evaporator a refrigerant according to claim 1.

16. The method of claim 15 wherein said refrigerant has a volumetric capacity in said system that is at least about 120% of the volumetric capacity of R-1233zd(E) in said system and wherein said refrigerant has a COP in said system that is at least 96% of the COP of R-1233zd(E) in said system.

17. A method of heating a heat sink comprising a fluid or body to be heated comprising:
a. providing a vapor compression refrigeration system comprising a compressor for compressing a refrigerant in a vapor phase, a condenser transferring heat from said vapor phase refrigerant to the heat sink at a temperature of about 40° C. or higher and a direct expansion evaporator transferring heat from a heat source at a temperature of about 80° C. or less to said refrigerant in the liquid phase, wherein said refrigerant comprises: at least about 95% by weight based on the total of all refrigerants of the following three components in the following relative concentrations:
i. from about 83% to about 89% by weight of HFO-1233zd(E);
ii. from about 4% to about 15% by weight of HFO-1234ze(E); and
iii. from about 2% to about 8% by weight of HFC-152a, wherein said refrigerant is 2 L; and
b. evaporating said refrigerant in said direct expansion evaporator, wherein said refrigerant has a volumetric capacity in said system that is at least about 120% of the volumetric capacity of R-1233zd(E) in said system.

18. The method of claim 17 wherein said refrigerant has a COP in said system that is at least 96% of the COP of R-1233zd(E) in said system.

19. A method of providing at least about 1 megawatt (1MW) of either district heating shared by a plurality of residential spaces or industrial heating to one or more fluid streams in an industrial process comprising:
(1) a vapor compression refrigeration system comprising: (i) one or more scroll, screw or centrifugal compressors receiving refrigerant vapors from one or more direct expansion evaporators; (2) one or more condensers receiving compressed refrigerant vapor from said one or more compressors; and (3) producing condensed liquid refrigerant feeding one or more expanders which produce liquid refrigerant feeding said one or more direct expansion evaporators;
(2) providing a heat source which directly or indirectly evaporates said liquid refrigerant in said one or more direct expansion evaporators,
(3) providing a heat sink which directly or indirectly condenses said vaporous refrigerant in said condenser, wherein when said system is district heating said heat sink comprises air and/or water circulating in each of said plurality of residences, wherein at least said one or more compressors is not located in said residences, wherein said heat sink comprises air and/or water circulating at a temperature of from about 40° C. to about 130° C. (preferably from about 60° C. to about 130° C.) and wherein said refrigerant comprises:
at least about 95% by weight based on the total of all refrigerants of the following three components in the following relative concentrations:
(a) from about 83% to about 89% by weight of HFO-1233zd(E);
(b) from about 4% to about 15% by weight of HFO-1234ze(E); and
(c) from about 2% to about 8% by weight of HFC-152a, wherein said refrigerant is 2 L;
(4) evaporating said refrigerant in said evaporator, wherein said refrigerant has an evaporator glide of from greater than about 3° C. less than 15° C.

20. The method of claim 19 providing at least about 1 megawatt (1MW) of industrial heating to one or more fluid streams in an industrial process wherein said step of providing a heat sink comprises providing a heat sink comprising one or more industrial process fluids and/or air and/or water at a temperature of from about 40° C. to about 130° C.
